(19) United States
(12) Patent Application Publication
(10) Pub. No.: US 2018/0291678 A1
(43) Pub. Date: Oct. 11, 2018

(54) CONTROL DEVICE FOR WINDOW BLIND

(71) Applicant: SONG-LI ZHENG, Guangdong (CN)

(72) Inventor: SONG-LI ZHENG, Guangdong (CN)

(21) Appl. No.: 15/482,833

(22) Filed: Apr. 10, 2017

(51) Int. Cl. E06B 9/322; E06B 9/307

(52) U.S. Cl. CPC E06B 9/322; E06B 9/307

(57) ABSTRACT

A control device comprises an upper fixing plate, a lower fixing plate, a coil spring, and a first gear and a second gear which are arranged between the upper and lower fixing plates. The first and second gears are engaged with each other. Each of the first and second gears has a coil spring fixing portion and a coil fixing portion arranged thereon. When the window blind is pulled up, one end of the coil spring is connected with the coil spring fixing portion of the first gear and the other end of the coil spring is winded around the coil spring fixing portion of the second gear. The gear structure may simplify the structure of the control device. The structure and the driving relation are easier and hard to malfunction and further to reduce the occupied space for being suitable for the window blinds with specific sizes.

### FIELD OF THE INVENTION

The present invention relates to a window blind, and more particularly to a cordless window blind and a control device thereof.

### BACKGROUND OF THE INVENTION

The window blind is beautiful and may be adjusted freely and keep private. Many people like to use to window blind to shading the transparent glass window. The traditional window blind may be drawn in and out manually, that is, the user may pull the pull cord to control the window blind to draw in and out with an adjusting device. It is not effective and laborious.

Now, the adjusting device is designed to improve the efficiency of drawing in and out the window blind. However, the design has the driving structure which has three gears in series or four gears in parallel. It needs large space to arrange ad not suitable for the window blind with specific size. And the driving relation of the drive structure is complicated and easy to malfunction due to lots of elements.

In view of the foregoing circumstances, the inventor has invested a lot of time to study the relevant knowledge, compare the pros and cons, research and develop related products. After quite many experiments and tests, the “control device for window blind” of this invention is eventually launched to improve the foregoing shortcomings, to meet the public use.

### SUMMARY OF THE INVENTION

An objective of this invention is providing a window blind and a control device thereof. It may improve the disadvantages of occupying large space and complicated.

To resolve above disadvantages, a control device for window blind comprises an upper fixing plate, a lower fixing plate, a coil spring, a first gear, and a second gear, wherein the first gear and the second gear are rotatably arranged between the upper fixing plate and the lower fixing plate, the first gear and the second gear are engaged with each other, and each of the first gear and the second gear has a coil spring fixing portion and a coil fixing portion arranged thereon; and wherein the window blind is pulled up, one end of the coil spring is connected with the coil spring fixing portion of the first gear and the other end of the coil spring is winded around the coil spring fixing portion of the second gear.

Preferably, a partition is arranged between the coil spring fixing portion and the cord fixing portion.

Preferably, a plurality of teeth is arranged at a peripheral of the partition, and the first gear and the second gear are engaged with each other by two partitions.

Preferably, a plurality of teeth is arranged at a top portion and/or a bottom portion of each of the first gear and the second gear, and the first gear and the second gear are engaged with each other by the teeth.

Preferably, at least one lead post is arranged at an outer side of each of the first gear and the second gear.

Preferably, a lead wheel is arranged at the outer side of each of the first gear and the second gear, and the lead wheel rotatably covers the lead post.

Preferably, a cordless window blind comprises above mentioned control device.

Preferably, the control device is fixed in a headrail of the window blind, a plurality of slats is arranged below the headrail, the slats are fastened by a ladder tape, a bottomrail is arranged below the slats, a direction-adjusting device is arranged at each of two sides of the control device, a plurality of through holes for providing each of two pull cords to pass through is respectively formed at the bottomrail, each of the slats, and the direction-adjusting device, one end of each of the two pull cords is connected to the corresponding cord fixing portion of the first gear and the second gear, and the other end of each of the two pull cords passes through the corresponding direction-adjusting device and then passes through the slats and bottomrail via the through holes.

Preferably, each of the direction-adjusting device includes a fixing bracket and two resistance wheels, the fixing bracket is fixed at the headrail of the window blind, the two resistance wheels are spaced apart from each other and respectively arranged on the fixing bracket through a fixing shaft, a direction-adjusting hole is formed at a bottom surface of the fixing bracket, the pull cords pass through the two resistance wheels and the direction-adjusting hole, and then the pull cords pass through the through holes of the slats and the bottomrail.

Preferably, the cordless window blind further comprises a light-adjusting device, the light-adjusting device includes an adjusting ohm with a turbine shaft mechanism, a roller, a connecting iron bar, and a rotation shaft; the turbine shaft mechanism is arranged in the adjusting ohm, part of the turbine shaft mechanism is exposed to the adjusting ohm, one end of the part of the turbine shaft mechanism is connected with the rotation shaft; the roller is arranged on the fixing bracket, the ladder tape is fixed to the roller; the connecting iron bar is used for connecting the turbine shaft mechanism and the roller so that the turbine shaft mechanism and the roller rotate synchronously; the bottomrail has a bottomrail cap for connecting the pull cords, the bottomrail cap cooperates with the through holes of the bottomrail to prevent the pull cords from shrinking back.

The control device may have following advantages. The control device of this invention comprise an upper fixing plate, a lower fixing plate, a coil spring, and a first gear and a second gear which are arranged between the upper fixing plate and the lower fixing plate. The first gear and the second gear are engaged with each other. Each of the first gear and the second gear has a coil spring fixing portion and a coil fixing portion arranged thereon. When the window blind is pulled up, one end of the coil spring is connected with the coil spring fixing portion of the first gear and the other end of the coil spring is winded around the coil spring fixing portion of the second gear. The gear structure or mechanism is improved to simplify the structure of the control device of the window blind so that the control device may be operated by two gears to realize the effects of driving mechanism with lots of gears. The structure and the driving relation are easier and hard to malfunction and further to reduce the occupied space of the control device for being suitable for the window blinds with specific sizes.

Further features and advantages of the present invention will become apparent to those of skill in the art in view of the detailed description of preferred embodiments which follows, when considered together with the attached drawings and claims.

### BRIEF DESCRIPTION OF THE DRAWINGS

All the objects, advantages, and novel features of the invention will become more apparent from the following detailed descriptions when taken in conjunction with the accompanying drawings.

FIG. 1 is an exploded view of a control device for window blind of the present invention.

FIG. 2 is a structural view of the window blind of the present invention.

FIG. 3 is an enlarged view of part A of FIG. 2.

FIG. 4 is a structural view of the window blind of the present invention viewed from another angle.

FIG. 5 is a top view of an embodiment of the pull cords winded around two lead posts of the present invention.

FIG. 6 is a top view of an embodiment of the pull cords winded around four lead posts of the present invention.

FIG. 7 is a top view of an embodiment of the pull cords winded around four lead posts of the present invention which is different from the embodiment of FIG. 6.

FIG. 8 is a top view of an embodiment of the pull cords winded around eight lead posts of the present invention.

FIG. 9 is an exploded view of a direction-adjusting device of the present invention.

FIG. 10 is a structural view of the resistance wheels and the fixing shaft in FIG. 9.

### DESCRIPTION OF THE PREFERRED EMBODIMENT

Referring now to the drawings where like characteristics and features among the various figures are denoted by like reference characters.

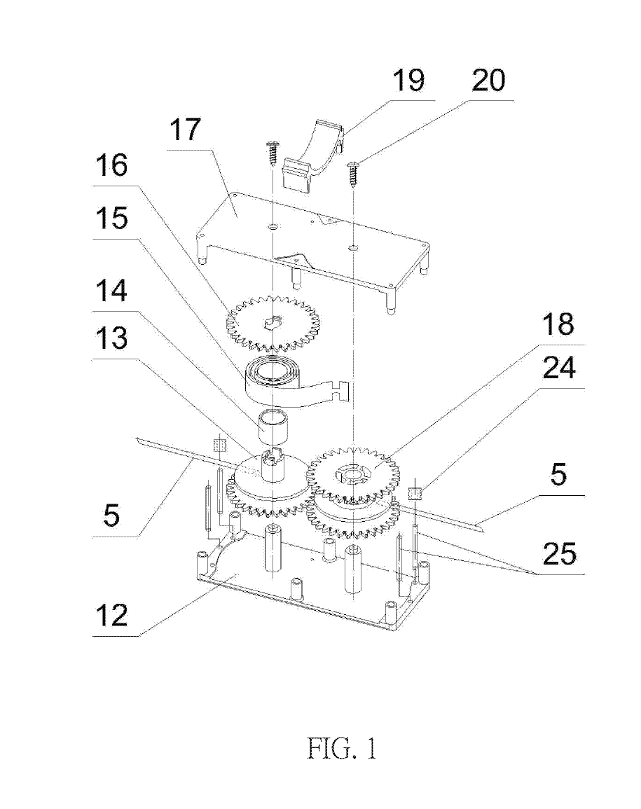

Please refer to FIGS. 1 to 10, a control device for window blind may comprise an upper fixing plate 17, a lower fixing plate 12, a coil spring 15, a first gear 16, and a second gear 18. The first gear 16 and the second gear 18 may be rotatably arranged between the upper fixing plate 17 and the lower fixing plate 12. The first gear 16 and the second gear 18 are engaged with each other. Each of the first gear 16 and the second gear 18 has a coil spring fixing portion and a coil fixing portion arranged thereon.

When the window blind is pulled up, one end of the coil spring 15 is connected with the coil spring fixing portion of the first gear 16, and the other end of the coil spring is winded around the coil spring fixing portion of the second gear. One end of each of two pull cords 5 winds around the cord fixing portions of the first gear 16 and the second gear 18, and the other end thereof extends to two ends of the control device without crossing and then passes through the slats 3 and the bottomrail 1.

The gravity of the slats 3, the friction between the pull cords 5 and the resistance wheels 10/fixing shaft 11, and the resilience of the coil spring 15 are balanced.

When the window blind is pulled down, the above mentioned forces do not balance anymore. The pull cords 5 drive the first gear 16 and the second gear 18 to rotate. The coil spring 15 gradually winds around the coil spring fixing portion of the first gear 16 from the coil spring fixing portion of the second gear 18. The window blind is extended downwardly. When the pull-down force is removed, the gravity of the slats 3, the friction between the pull cords 5 and the resistance wheels 10/fixing shaft 11, and the resilience of the coil spring 15 are balanced again. The first gear 16 and the second gear 18 stop rotating so that the window blind may stop at the location what the user wants.

When the window blind is pulled up, the above mentioned forces do not balance due to the pull-up force. The coil spring 15 is rebounded or reset. That is, the second gear 18 rotates reversely (opposite to the direction while the window blind is pulled down). The coil spring 15 gradually winds around the coil spring fixing portion of the second gear 18 from the coil spring fixing portion of the first gear 16. The first gear 16 and the second gear 18 rotate simultaneously so as to pull up the window blind. When the pull-up force is removed, the gravity of the slats 3, the friction between the pull cords 5 and the resistance wheels 10/fixing shaft 11, and the resilience of the coil spring 15 are balanced again. The first gear 16 and the second gear 18 stop rotating so that the window blind may stop at the location what the user wants.

According to above descriptions, the structure of the gears is improved and the control device is simplified so that the control device may be operated by two gears to realize the effects of driving mechanism with lots of gears. The structure and the driving relation are easier and hard to malfunction and further to reduce the occupied space of the control device for being suitable for the window blinds with specific sizes. Especially, it is convenient to mount the window blind in a small space so as to make it beautiful. It may reduce cost and have better practicability.

It should be noted that the first gear 16 and the second gear 18 may exchange their positions according to the winding directions of the pull cords 15 and the coil spring 15.

In one embodiment, shown as in FIG. 1, an upper end and a lower end of each of the first gear 16 and the second gear 18 are formed engaging teeth circumferentially. The coil spring fixing portion and the pull cord fixing portion are arranged between the engaging teeth of the upper end and the engaging teeth of the corresponding lower end. The first gear 16 and second gear 18 are engaged with each other by the engaging teeth so that the first gear 16 and the second gear 18 are forced evenly and make the window blind more stable.

In order to prevent the pull cords 5 and the coil spring 15 from interfering with each other, in another embodiment, a partition 13 is arranged between the coil spring portion and the pull cord fixing portion.

In addition, lots of engaging teeth are formed at the partition 13 circumferentially. The first gear 16 and the second gear 18 are engaged with each other by the engaging teeth of the partition 13 so as to achieve the effect of simultaneous rotation for the first gear 16 and the second gear 18.

Preferably, the coil spring portion of the first gear 16 has a sleeve 14 which may freely rotate relative to first gear 16. The coil spring 15 winds around the sleeve 14. One end of the coil spring 15 is fixed on the second gear 18. When the second gear 18 and the first gear 16 rotate relatively, the coil spring 15 gradually winds around the second gear 18 from the first gear 16. In this process, the coil spring 15 drives the sleeve 14 to rotate. When the first gear 16 and the second gear 18 rotate in an opposite direction relative to the above mentioned direction, the coil spring 14 winds around the sleeve 14 again. In this process, the coil spring 15 has springback so as to be more labor-saving to pull up and down the window blind.

Furthermore, in order to be more labor-saving to pull up and down the window blind, preferably, the coil spring may be a variable-force coil spring. Preferably, the diameter of each end of the variable-force coil spring is smaller than the diameter of the middle section of the variable-force coil spring to make sure that the window blind do not move back while being pulled up or down and make more labor-saving while pulling up and down the window blind.

Specifically, the position of the window blind may be changed or kept by the springback or resilience of the coil spring 15. Because the diameter of the coil spring 15 is smaller and the springback or resilience is larger, the diameter of the middle section of the coil spring 15 which is a relative short part may be increased suitably and the diameter of each end of the coil spring 15 may be reduced relatively so as to balance and make the window blind keep firmly while being pulled up or down. The diameter of the middle section of the coil spring 15 which is a relative longer part is relatively larger than the diameter of each end of the coil spring 15 so that the springback or resilience of the coil spring 15 may be reduced to achieve the effect of saving labor.

It should be noted that the diameter of the middle section of the coil spring 15 may be isometric or gradually increased. That is, the diameter of the middle section of the coil spring may only suitably larger than the diameter of each end of the coil spring 15. When the window blind is pulled sown, the springback or resilience of the middle section of the coil spring 15 may be not increased but reduced gradually. When the window blind is pulled up, the springback or resilience of the coil spring may be gradually increased so as to quickly pull up the window blind and prevent the window blind from dropping.

In FIG. 1, a plurality of fixing portions is arranged between the upper fixing plate 17 and the lower fixing plate 12. Preferably, each fixing portion is the structure of the bushing and the pin. For example, the pin is arranged at the upper fixing plate 17 and the bushing is arranged on the lower fixing plate 12 so that the upper fixing plate 17 and the lower fixing plate 12 are assembled to each other by the pin and the bushing.

In this embodiment, shown as in FIG. 1, three rows of bushings are arranged on the lower fixing plate 12. Two of the three rows which are arranged at two sides respectively have three bushings for each. The bushings which are arranged at the center row cover the first gear 16 and the second gear 18 for fixing. The pin is protruded from the bushing. The first gear 16 and the second gear 18 may be respectively and rotatably cover two bushings. The upper fixing plate 17 has two rows of protruding pins which may be corresponding to the bushings which are arranged at two side rows. When the upper fixing plate 17 and the lower fixing plate 12 are assembled to each other, the pins and corresponding bushings are engaged with each other and the first gear 16 and the second gear 18 are rotatably fixed between the upper fixing plate 17 and the lower fixing plate 12.

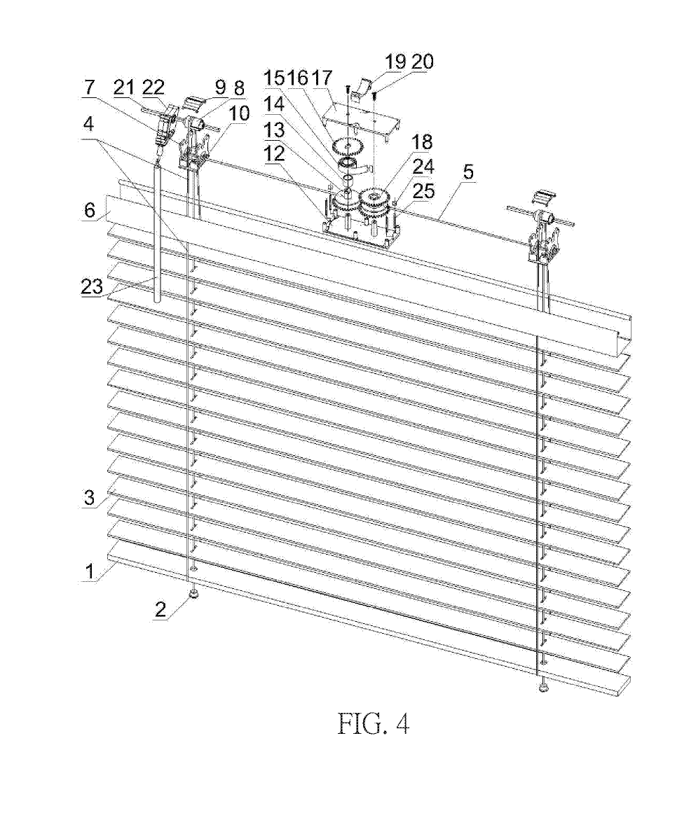

In FIGS. 1 and 4, the control device uses the screws 20 to fix the lower fixing plate 12 and the upper fixing plate 17. Preferably, a sticking member 19 is arrange outside of the upper fixing plate 17 for sticking the control device in the headrail 6.

In FIG. 1, each pin which is arranged between the upper fixing plate 17 and the lower fixing plate 12 has a suitable height. When the upper fixing plate 17 and the lower fixing plate 12 are assembled to each other, a space is defined between the first fixing plate 17 and the lower fixing plate 12 and the pull cords 5 may pass through the space and then be pulled out to extend two sides respectively without crossing. Two lead posts 25 are arranged between the upper fixing plate 17 and the lower fixing plate 12. The two lead posts 25 are respectively arranged at an outside of the first gear 16 and an outside of the second gear 18. The pull cords 5 are pulled out through the lead posts 25. When the pull cords 5 are forced or pulled, they always tightly contact the lead posts 25 to prevent the pull cords 5 from slanting.

Furthermore, a lead wheel 24 covers the lead post 25. A lead groove is arranged on the lead wheel 24 for fixing the pull cord 5. The lead wheel 24 may rotate relative to the lead post 25. When the pull cord 5 is pulled, the lead wheel 24 rotates to reduce the friction formed between the pull cord 5 and the lead wheel 24.

In FIG. 6, in this embodiment, the outer side of the first gear 16 and the outer side of the second gear 18 are respectively arranged two lead posts 25. Specifically, one lead post 25 is arranged between two pins and the other lead post 25 is arranged adjacent to the upper-side (the direction is defined in FIGS. 6, 7 and 8) pin. The pull cord 5 passes through the lead post 25 adjacent to the pin and the lead post 25 between two pins in series and then extends from the control device. I FIG. 7, in another embodiment, if the friction of the pull cord 5 needs to be increased, one of the two lead posts 25 may be arranged adjacent to the lower-side (the direction is defined in FIGS. 6, 7 and 8) pin. In this embodiment, preferably, the lead wheel 24 which may rotate relative to the lead post 25 may cover at least one lead post 25. More preferably, when only one lead wheel 24 is arranged, the lead wheel 24 covers the lead post 24 which is adjacent to the pin to reduce the abrasion of the pull cord 5.

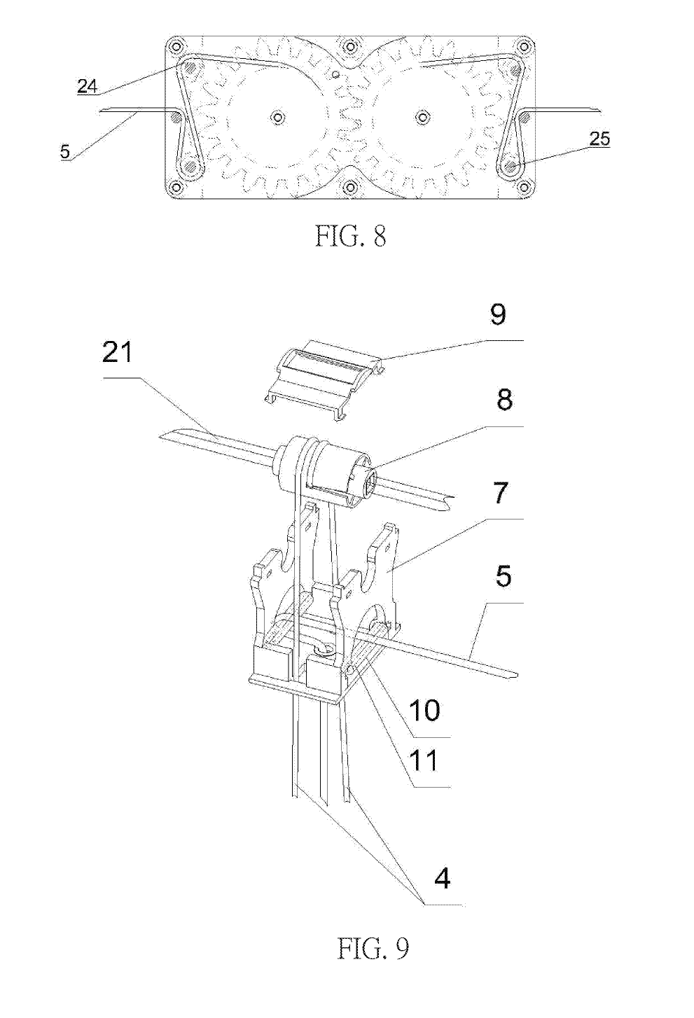

In FIG. 8, the outer side of the first gear 16 and the outer side of the second gear 18 are respectively arranged three lead posts 25. Specifically, the first lead post 25 is arranged between the two pins, the second lead post 25 and the third lead post 25 are respectively arranged adjacent to the upper-side pin and the lower-side pin (the direction is defined in FIGS. 6, 7 and 8). The pull cord 5 passes through the second lead post 25 and the third lead post 25 arranged adjacent to two pins and the first lead post 25 arranged between the two pins in series and then extends from the control device.

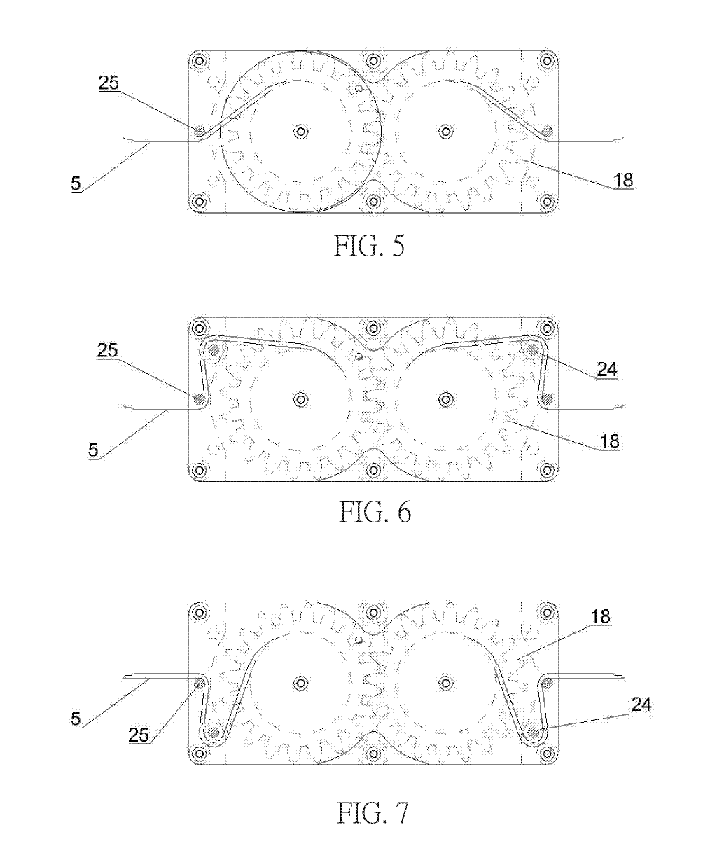

The four winding manners are shown in the FIGS. 5 to 8. The friction forced to pull cord 5 is gradually increased. The winding manner may be selected according to different demands.

It should be noted that the winding manners on the lead post 25 may be changed according to the winding direction of the gear(s).

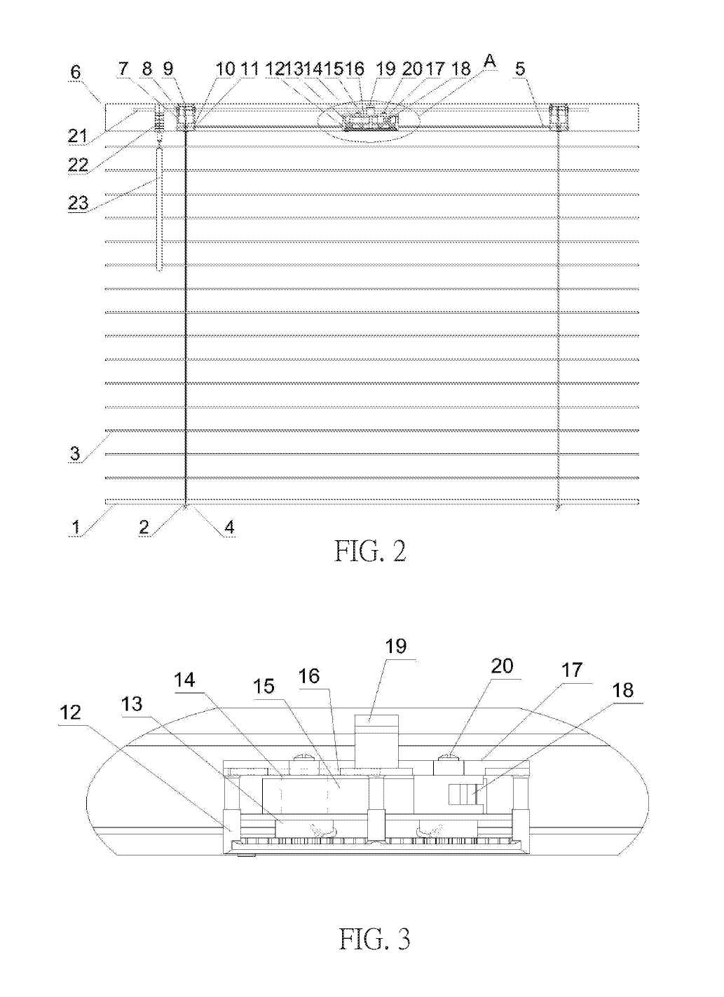

Please refer to FIGS. 2 to 4, a cordless window blind with the control device is provided. The window blind comprises a headrail 6, a bottomrail 1, a plurality of slats 3, and a ladder tape 4 for fixing the slats 3. The control device is fixed in the headrail 6 of the window blind. The slats 3 are arranged below the headrail 6. The slats 3 are fastened by the ladder tape 4 and parallel to the headrail 6. The bottomrail 1 is arranged below the slats 3. A direction-adjusting device is arranged at each of two sides of the control device. A plurality of through holes for providing each of two pull cords to pass through is respectively formed at the bottomrail 1, each of the slats 3, and the direction-adjusting device. The through holes of the slats and the bottomrail 1 are coaxial. In this embodiment, two pull cords 5 are corresponding to two direction-adjusting devices. One end of each of the two pull cords 5 is connected to the corresponding cord fixing portion of the first gear 16 and the second gear 18, and the other end of each of the two pull cords 5 passes through the corresponding direction-adjusting device and then passes through the slats 3 and bottomrail 1 via the through holes. The window blind uses the control device with the coil spring 15 to control the window blind up and down to prevent from operating many times and increase up-and-down speed. It may make the two pull cords 5 to act synchronously and operate easily. The pull cords 5 pass through the slats 3 and the inner side of the bottomrail 1 so as to prevent from knotting.

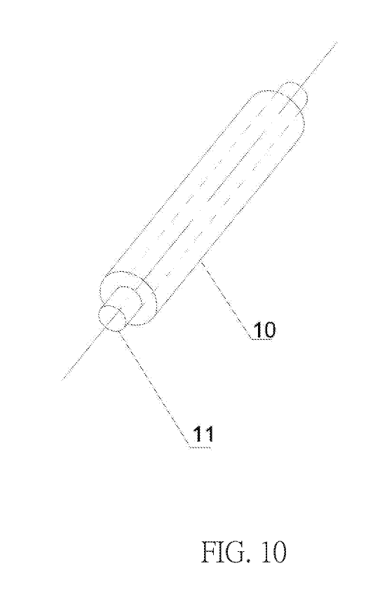

In FIGS. 9 and 10, each of the direction-adjusting devices includes a fixing bracket 7, a direction-adjusting hole, and two resistance wheels 10. The fixing bracket 7 is fixed at the headrail 6 of the window blind. The two resistance wheels 10 are spaced apart from each other and respectively arranged on the fixing bracket 7 through a fixing shaft 11. The direction-adjusting hole is formed at a bottom surface of the fixing bracket 7 and located below the two resistance wheels 10. Preferably, the direction-adjusting hole is arranged above the through holes and their sizes are the same. The peripheral of the direction-adjusting hole is circular so as to reduce the abrasion of the pull cords 5. The pull cords 5 pass through the two resistance wheels 10 (contact with the two resistance wheels 10 simultaneously) along the horizontal direction and the direction-adjusting hole, and then the pull cords 5 pass through the through holes of the slats 3 and the bottomrail 1 vertically. The direction-adjusting device may not only change the operating direction of the pull cords 5, but also to a certain extent increase the friction to the pull cords 5 to reduce the rate of sliding the pull cords 5. The direction-adjusting hole is one part of the fixing bracket 7 so as to reduce the quantity of the required elements of the direction-adjusting device. It may also limit the pull cords 5 so that the pull cords 5 may not move transversely in the direction-adjusting device.

Additionally, the cordless window blind further comprises a light-adjusting device. The light-adjusting device includes an adjusting ohm 22, a roller 8, and a connecting iron bar 21. Specifically, in FIG. 10, the roller 8 is double-layer structure. An outer layer thereof has two opposite openings. The ends of two lines of the ladder tape 4 are respectively fixed on the roller 8. When fixing, the end of the ladder tape 4 are stuck to the opening arranged at one side of the roller 8. After the ladder tape 4 winds around the roller 8 with half circle, it extends downwardly from the opening arranged at the other side of the roller 8. The other ladder tape 4 uses the same manners to fix. The adjusting ohm 22 includes a shell and a turbine shaft mechanism arranged in the shell. The turbine is arranged in the shell and part of the shaft is exposed to the adjusting ohm 22. The roller 8 is arranged in the slot of the fixing bracket 7. The connecting iron bar 21 connects with the roller 8 and the turbine so that the roller 8 and the turbine rotate synchronously. The shaft which protrudes from the adjusting ohm 22 is rotated to drive the turbine, and then the connecting iron bar 21 drives the roller 8 to rotate. The ladder tape 4 may rotate with the roller 8 to adjust the angle of the slats 3 further to realize light adjusting. The ladder tape 4 may wind around the roller 8 with double-layer structure so as to make the ladder tape 4 be fixed more convenient.

In order to prevent the connecting iron bar 21 and the turbine or the roller 8 from sliding relatively, preferably, the cross-section of the connecting iron bar 22 is non-circular. Furthermore, a fixing cap 9 is arranged on the fixing bracket 7 so as to prevent the ladder tape 4 from sliding from the roller 8 to stick in the space which is defined between the roller 8 and the fixing bracket 8 to influence the turning of the slats 3.

In order to conveniently adjust light, shown as in FIGS. 2 and 4, the end protruded from the adjusting ohm 22 has a hook. A rotation shaft 23 is arranged for cooperate with the hook. While in operation, the rotation shaft 23 increases the length of the shaft of the turbine shaft mechanism and may be picked up in any angle.

In addition, in order to prevent the pull cords from shrinking back, the bottomrail 1 has a bottomrail cap 2 corresponding to the through hole for connecting the pull cords 5. Preferably, the bottomrail cap 2 is a robber cap. After the pull cord 5 passes through the trough hole of the bottomrail 1 and extends therefrom, the pull cord 5 further passes through the bottomrail cap 2 and the end of the pull cord 5 is knotted so that the bottomrail cap 2 may be not removed. And then, the bottomrail cap 2 may be assembled to the through hole of the bottomrail 1.

The foregoing descriptions are merely the exemplified embodiments of the present invention, where the scope of the claim of the present invention is not intended to be limited by the embodiments. Any equivalent embodiments or modifications without departing from the spirit and scope of the present invention are therefore intended to be embraced.

The disclosed structure of the invention has not appeared in the prior art and features efficacy better than the prior structure which is construed to be a novel and creative invention, thereby filing the present application herein subject to the patent law.

1. A control device for window blind, comprising an upper fixing plate, a lower fixing plate, a coil spring, a first gear, and a second gear, wherein the first gear and the second gear are rotatably arranged between the upper fixing plate and the lower fixing plate, the first gear and the second gear are engaged with each other, and each of the first gear and the second gear has a coil spring fixing portion and a cord fixing portion arranged thereon; and
wherein a plurality of teeth is arranged at a top portion and a bottom portion of each of the first gear and the second gear, and the first gear and the second gear are engaged with each other by the teeth.

2. The control device as claimed in claim 1, wherein a partition is arranged between the coil spring fixing portion and the cord fixing portion.

3. The control device as claimed in claim 2, wherein a plurality of teeth is arranged at a peripheral of the partition, and the first gear and the second gear are engaged with each other by two partitions.

4. (canceled)

5. The control device as claimed in claim 1, wherein at least one lead post is arranged at an outer side of each of the first gear and the second gear.

6. The control device as claimed in claim 5, wherein a lead wheel is arranged at the outer side of each of the first gear and the second gear, and the lead wheel rotatably covers the lead post.

7. A cordless window blind, comprising the control device claimed in anyone of claims 1-6.

8˜10. (canceled)
